(19) United States
(12) Patent Application Publication
(10) Pub. No.: US 2017/0169521 A1
(43) Pub. Date: Jun. 15, 2017

(54) SYSTEMS AND METHODS FOR GIFTING PHYSICAL ITEMS

(71) Applicant: Ad Res Pty Ltd, New South Wales (AU)

(72) Inventor: Christopher Henry, New South Wales (AU)

(21) Appl. No.: 15/115,570

(22) PCT Filed: Dec. 3, 2014
(86) PCT No.: PCT/AU2014/050392

§ 371 Date: Jul. 29, 2016

(30) Foreign Application Priority Data
Jan. 30, 2014 (AU) 2014900272
Sep. 26, 2014 (AU) 2014903839

(51) Int. Cl. G06Q 50/00; G06Q 10/08; G06Q 20/12

(52) U.S. Cl. CPC G06Q 50/01; G06Q 20/12; G06Q 10/083

(57) ABSTRACT

A system and method of gifting one or more physical items to a recipient including the steps of: preparing to gift information relating to a gift which a donor wishes to give to an intended recipient, the gift information including physical item information identifying at least one physical item, donor information identifying the donor, and recipient contact information enabling contact to be made with the intended recipient; obtaining payment from the donor in relation to the gift; providing the at least one physical item to the recipient according to delivery information derived from the intended recipient; wherein the delivery information includes information identifying a delivery address or pick up location; associating a donor transaction identifier with the gift information; associating a recipient transaction identifier with the gift information; the donor transaction identifier is not ascertainable by the recipient; recipient transaction identifier is not ascertainable by the donor; wherein the donor transaction identifier is different to the recipient transaction identifier.

### TECHNICAL FIELD

The invention relates to systems and methods for gifting physical items to recipients. The invention has particular application where a person desirous of sending a gift to another person has only limited contact information for them.

### BACKGROUND TO THE INVENTION

As a result of recent advances in communications a person may have social contacts or friends, yet not know their real identities or address details. For example, many people regularly communicate with one another within the context of playing online games together and consider themselves to be friends, yet they may only know each other's online nicknames.

In the context of social networking websites such as dating sites, a person will usually have an online nickname. This nickname is usually associated with an online profile which will include various information about a person which they agree to make available to other website members such as their general location (country and city) and their hobbies and interests. However, real name and specific address information is typically withheld from such profile pages to guard against unsolicited contact being made outside of the website and to guard against aspects of identity theft.

As a result, one is often not in the position of holding sufficient information in relation to online contacts to allow the sending of a physical gift to an online contact.

### SUMMARY OF THE INVENTION

In a first aspect the present invention provides a method of gifting one or more physical items to a recipient including the steps of: preparing gift information relating to a gift which a donor wishes to give to an intended recipient, the gift information including physical item information identifying at least one physical item, donor information identifying the donor, and recipient contact information enabling contact to be made with the intended recipient; obtaining payment from the donor in relation to the gift; providing the at least one physical item to the recipient according to delivery information derived from the intended recipient; wherein the delivery information includes information identifying a delivery address or pick up location; associating a donor transaction identifier with the gift information; associating a recipient transaction identifier with the gift information; the donor transaction identifier is not ascertainable by the recipient; recipient transaction identifier is not ascertainable by the donor, and wherein the donor transaction identifier is different to the recipient transaction identifier.

The method may further include the step of notifying the intended recipient that a gift is intended for them and seeking an indication from the intended recipient as to whether they wish to receive the gift; and the step of providing the at least one physical item to the intended recipient is carried out only if the intended recipient indicates that they wish to receive the gift.

The step of obtaining payment may includes two stages: A) obtaining payment authorisation prior to notifying the intended recipient of the fact that a gift is intended for them; and B) processing the payment only if the intended recipient indicates that they wish to receive the gift.

The method may further include the step of providing the intended recipient with information identifying the at least one physical item.

The method may further including the step of providing the intended recipient with information identifying the donor.

In a second aspect the present invention provide a system for gifting one or more physical items to a recipient including: preparation means for preparing gift information relating to a gift which a donor wishes to give to an intended recipient, the gift information including physical item information identifying at least one physical item, donor information identifying a donor, and recipient contact information enabling contact to be made with the intended recipient; obtaining means for obtaining payment from the donor in relation to the gift and for obtaining delivery information derived from the intended recipient; wherein the delivery information includes information identifying a delivery address or pick up location; associating means for associating a donor transaction identifier with the gift information and for associating a recipient transaction identifier with the gift information; and wherein the donor transaction identifier is different to the recipient transaction identifier.

In a third aspect the present invention provides a software program including instructions which, when carried out by a processor, cause a computing system to operate a method according to the first aspect of the invention or to embody a system according to the second aspect of the invention.

In a fourth aspect the present invention provides a computer readable medium which is populated with a software program according to the third aspect of the invention.

### BRIEF DESCRIPTION OF THE DRAWINGS

An embodiment of the present invention will now be described, by way of example only, with reference to the accompanying drawings, in which:

FIG. 1 is a schematic diagram illustrating a system according to an embodiment of the invention,

FIGS. 2 to 4 are flow charts setting out the steps taken in carrying out embodiments of the invention; and

FIGS. 5 and 6 show user interfaces used in the system of FIG. 1.

### DETAILED DESCRIPTION OF THE PREFERRED EMBODIMENT

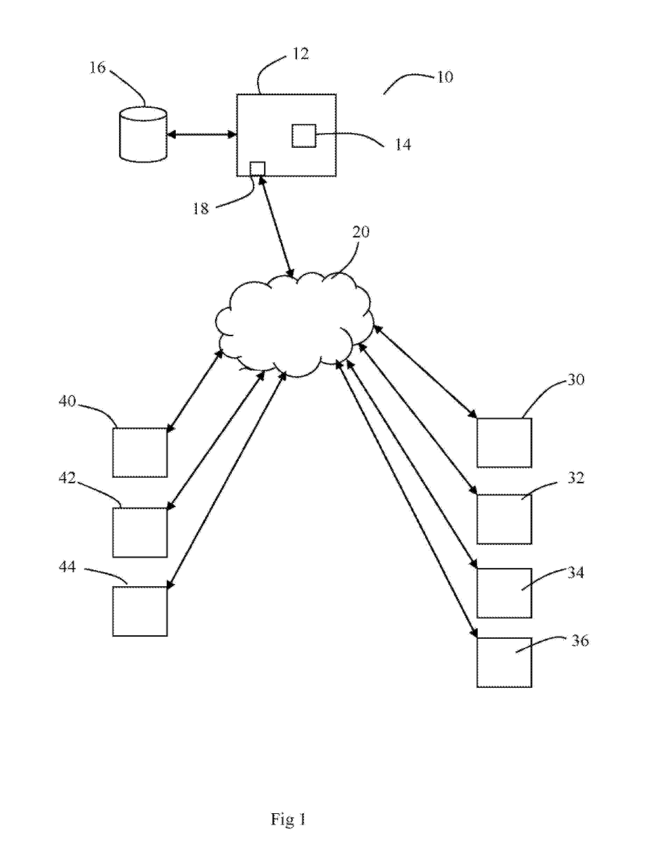

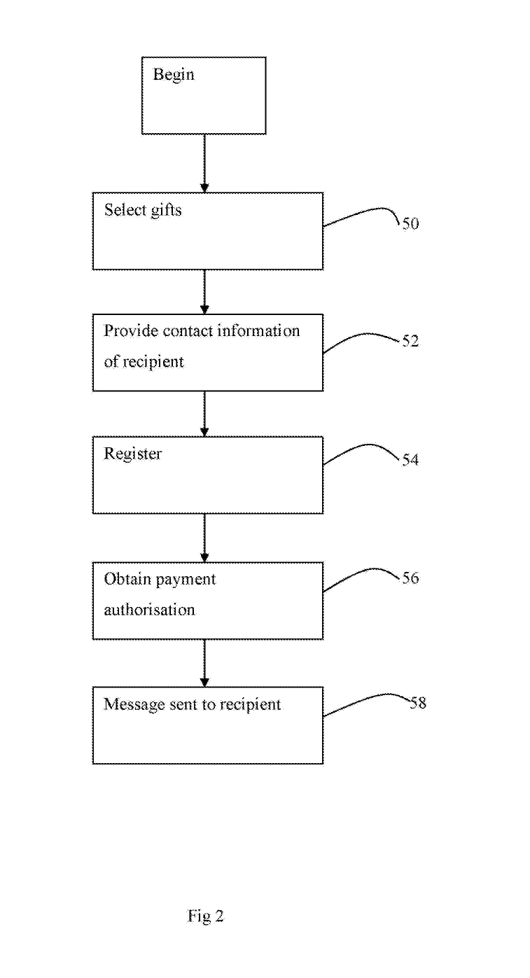

Referring to FIG. 1, a system 10 is shown for enabling the gifting of physical items between people 40, 42, 44. The physical items are provided by vendors 30, 32, 34, 36. The system 10 is embodied in an internet connected server computer 12 running suitably configured software under control of an operating system by way of a typical processor and memory architecture 14. Server 12 is connected to database 16 used for storing and retrieving information used in operating the system. Server 12 communicates via the internet 20 by way of router 18 to receive and transmit information used in the system as will be later described.

Vendors 30, 32, 34, 36 participate in the system and have the ability to log into the back-end of the site and manage their own stock and orders to:
Add, edit or delete their products and manage stock levels
View purchase orders
Manage shipping status of their order
Interact with customers directly
Temporarily disable the availability of their products if needed

Administrators of system 10 can use an administrator's interface to:
Add, edit or delete vendors
Generate financial statements for vendors, either manually or automated
View all customers and orders, as normal

System 10 operates on the principle that the recipient's real identity or delivery details are not made available to the donor at any stage.

Operation of the system will now be described with reference to an example of a gift being arranged using the system 10 by a person (hereinafter “donor 40”) to another person (hereinafter “recipient 42”).

The donor 40 is desirous of sending a gift to a friend being recipient 42. In this example the user knows a nickname and an email address of the recipient, they do not know their real name or home address to enable them to send them a gift directly.

At step 50, donor 40 uses their own computing device such as a personal computer or mobile computing device to view a website interface which is presented by web server 12 or to interact with a mobile phone application which is populated by data provided by web server 12. The website interface enables the preparation of gift information relating to a gift which a donor wishes to give to an intended recipient, the gift information including physical item information identifying at least one physical item, donor information identifying the donor, and recipient contact information enabling contact to be made with the intended recipient.

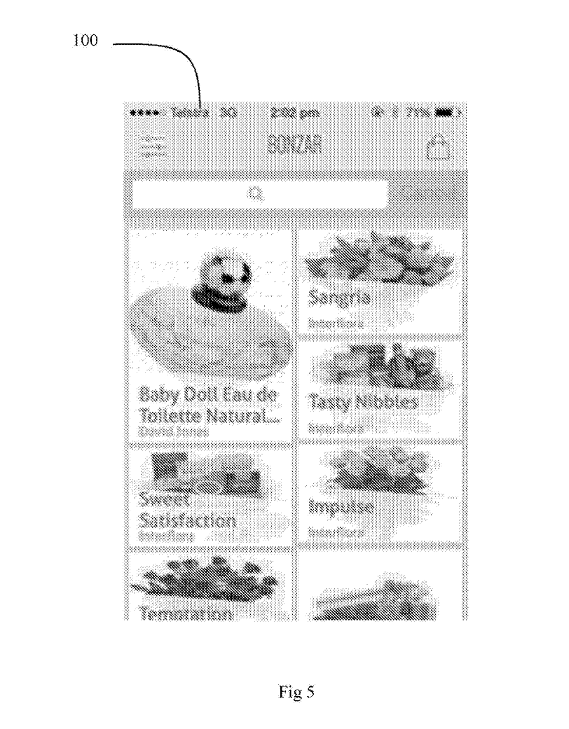

The donor peruses and selects from physical items (see interface 100 shown in FIG. 5) which are available from a range of vendors 30, 23, 34. Alternatively, each of vendors 30, 32, 34 may provide an embedded facility or option in their own on-line stores to interface with system 12. In this example, donor 40 elects to send a floral arrangement which is offered by vendor 30.

At step 52, the donor 40 provides contact information enabling contact to be made with the recipient, in this example, an email address Jo45aemail.com along with a nickname they know the recipient by, Jo45.

At step 54, the user is prompted to login to their account with the operator of system 10. If this is the first time they have arranged a gift through the system then they are required to register with the system in a conventional manner, selecting a username and password combination and providing their own contact details and details of a method of payment such as a credit card or online payment facility such as Paypal.

As well as providing their full name and address details, the donor may select a nickname which identifies them to the intended recipient. In this example, “Chipper”. The donor may also select whether or not the recipient is notified of details of the physical selected by the donor, or whether this information is hidden from them. In this example the donor elects that the recipient will be notified that the physical item is a particular floral arrangement.

At step 56, the system 10 obtains a payment authorisation from the payment facility nominated by the donor for an amount to cover the purchase. The amount of payment includes a built-in amount to cover the vendor's likely costs for delivering the item to the intended recipient. Because the actual delivery location is not known at this stage, the delivery cost is set at an estimated amount which, on average, will cover the delivery costs of the vendor. This amount can be specified by each vendor.

If the payment authorisation is successful then at step 58 the system sends a notification email message to notify the intended recipient that a gift is intended for them.

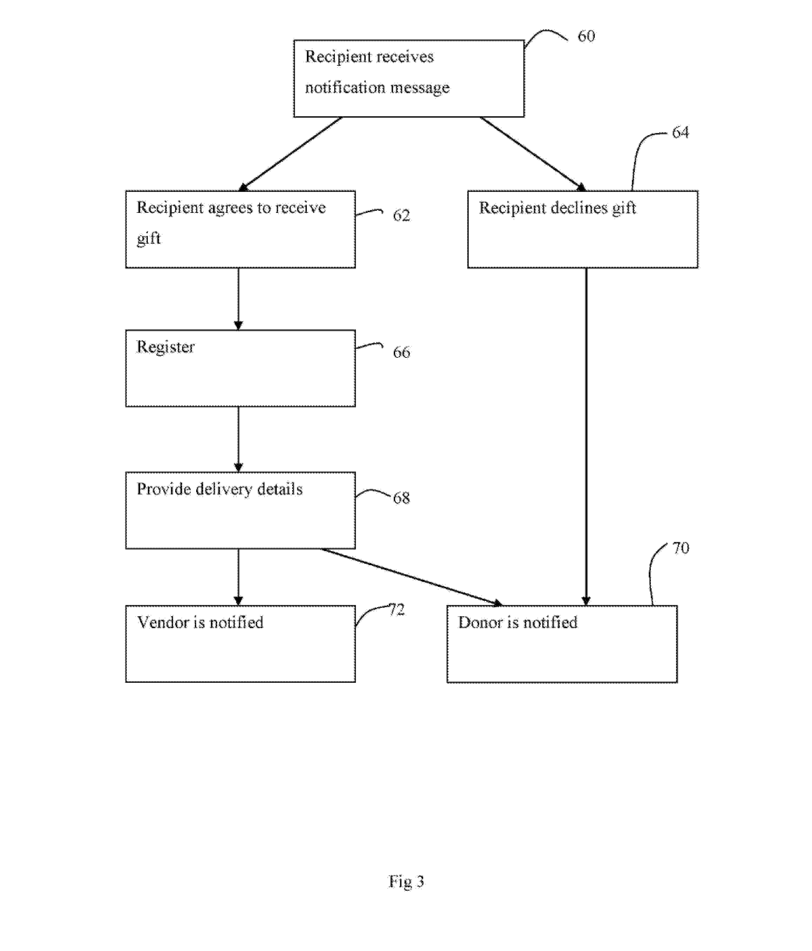

Referring to FIG. 3, at step 60 the intended recipient receives the email message they were sent. The message informs the intended recipient that a gift is waiting for “Jo45” from “Chipper”. This allows them to understand the origin of the gift, although they may not necessarily know Chipper's real name or identity, and Chipper may not know theirs.

The email message contains a secure link to a website associated with the system 10 (containing a long hashed URL) as well as a code the recipient must enter to receive the gift. These measures prevent others from randomly ‘guessing’ gift urls and claiming them for themselves. After validating that the gift URL and code is correct, the site then asks if the recipient wishes to accept or reject the gift.

At step 64, if rejecting the gift, the recipient can optionally enter a reason. After confirmation, they can simply close the site, and the purchaser will be notified by email that the recipient declined to receive the gift. No funds are deducted from the payment account of the donor in this case.

At step 62, if accepting the gift, the recipient is prompted to login to their account with the operator of system 10. If they do not have an existing account, they will be required to register 66 and create one in the same fashion as for the donor described above. Once logged in, at step 68 the recipient specifies delivery details which can be the selection of an existing delivery address already on file, or the entering of a new one. Alternatively, vendors may allow the option of the recipient specifying a collection location where they will collect their gift.

At step 70, the donor is sent a confirmation message informing them that the gift has been accepted, and the previously authorised payment will be deducted from their specified payment account.

System 10 associates a donor transaction identifier with the gift information by assigning a donor reference code to the transaction. System 10 also associates a recipient transaction identifier with the gift information by assigning a recipient reference code with the gift information. The donor reference code and the recipient reference code are different. This prevents donors and recipients from matching up their transactions outside of the system and ensures confidentiality of real identities and personal confidential information.

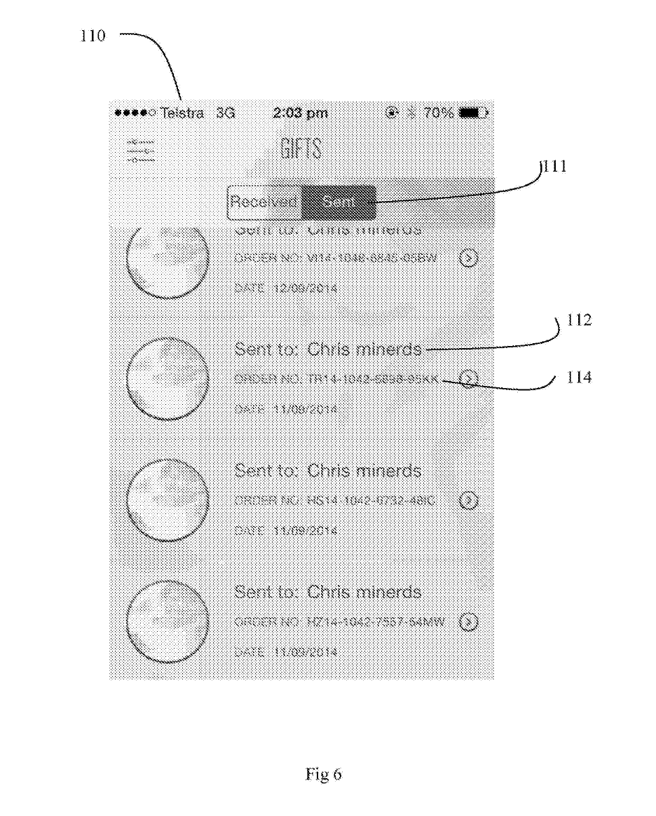

Referring to FIG. 6, a user can view the history of their use of the system 10. Any user can send or receive gifts in the context of being either a sender or receiver. They choose to view either their received or sent history by way of Received/Sent selector 111. In FIG. 6, a user is viewing history of gifts they have sent. For each gift the user name of the recipient 112 is shown along with the donor reference code 114 for that transaction.

At step 72, a purchase order will be visible to the vendor of the item(s). The vendor will also receive an email notification. The vendor is made aware only of the recipient reference number.

Details of the gift are now visible to the recipient via the website. Additionally, should the recipient wish to preview an image of the gift, a portal within the login area will provide a display. The gift will be visible in the recipient's login area, under a ‘My Gifts’ tab. Here all gifts they have received are listed, but they have access only to limited information (namely the name of products, the recipient reference code and the delivery status).

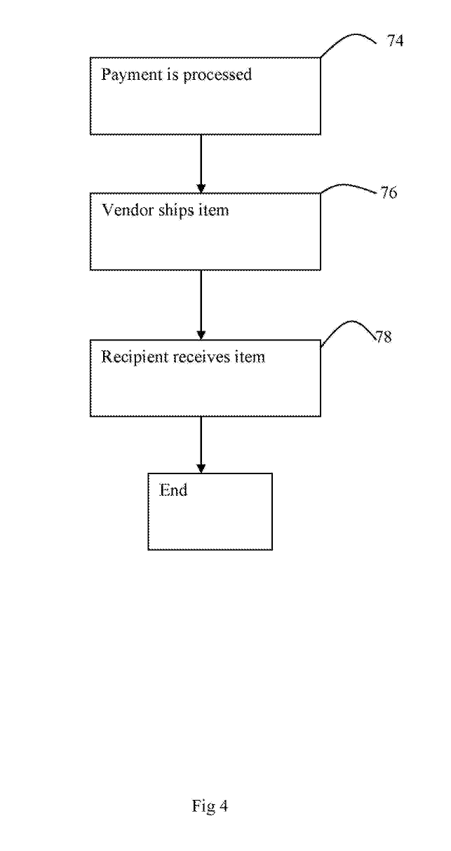

Referring to FIG. 4, at step 74 the previously authorised payment is now actually deducted from the account of the donor to an account of the vendor.

At step 76 the vendor ships the item or makes the item available for collection by the recipient according to the delivery information derived from the recipient at step 68. At step 78 the recipient receives the item.

In the embodiment described above, the donor knew an email address of the recipient and notification was made to the recipient by sending an email message. In other embodiments the system may operate by way of an application that is available in conjunction with a social media platform such as Facebook, Twitter and LinkedIn. If a donor accesses the system via a social media platform such as Facebook, a popup box is displayed which requests access to the application from their Facebook account. If the donor accepts, their friend list will be displayed, and the purchaser can select the recipient from their friends list. In an embodiment of this type, the intended recipient can be notified of the intended gift by way of the social networking platform such as by way of a Facebook message. Such messages may also cause an email notification to be sent to the user, depending upon the preferences previously set by the user in relation to their Facebook user account.

In some embodiments the system may include wish list functionality. A user can create an account with the operator of system 10, browse the site and add items to their wish list. This wish list can then be shared with friends via email or social widgets (such as via Facebook).

Embodiments of the invention may interact with other types of existing platforms which allow users to be contacted such as dating websites, professional networking sites such as LinkedIn, multiplayer gaming systems or other specialised platforms or groups.

In some embodiments, as well as declining or accepting the gift, the intended recipient can instead decide to donate the gift to a third party, such a charity organisation. The donor can be notified that the gift has been redirected to the third party.

In some embodiments, the system may enable several donors to pool funds or create a register of gifts through a vendor to be gifted to an intended recipient. This would serve to function as a multiple donor gateway for events such as marriages, births and charities. For the purpose of these types of embodiments, the term “donor” is a reference to a group of donors.

It can be seen that embodiments of the invention have at least one of the following advantages:
A gift can be given to a person even if the real name or physical address details of that person are not known
A gift can be given between two persons whilst preventing either person from discovering each other's personal identity or address details.
The decision as to whether or not to accept the gift is under the control of the recipient. At all times, the decision power resides with the recipient.
Payment is only deducted from a payment account of the donor if the recipient elects to accept the gift
Differing donor and recipient reference codes results in that information cannot be traceable by the donor to uncover a recipient's personal identity or address details.
Donation of gifts to persons can be initiated even if they are not currently registered with the system.

Any reference to prior art contained herein is not to be taken as an admission that the information is common general knowledge, unless otherwise indicated.

Finally, it is to be appreciated that various alterations or additions may be made to the parts previously described without departing from the spirit or ambit of the present invention.

1. A method of gifting one or more physical items to a recipient including the steps of:
preparing gift information relating to a gift which a donor wishes to give to an intended recipient, the gift information including physical item information identifying at least one physical item, donor information identifying the donor, and recipient contact information enabling contact to be made with the intended recipient;
obtaining payment from the donor in relation to the gift;
providing the at least one physical item to the recipient according to delivery information derived from the intended recipient;
wherein the delivery information includes information identifying a delivery address or pick up location;
associating a donor transaction identifier with the gift information;
associating a recipient transaction identifier with the gift information;
the donor transaction identifier is not ascertainable by the recipient;
recipient transaction identifier is not ascertainable by the donor;
wherein the donor transaction identifier is different to the recipient transaction identifier.

2. A method according to claim 1 further including the step of notifying the intended recipient that a gift is intended for them and seeking an indication from the intended recipient as to whether they wish to receive the gift; and
the step of providing the at least one physical item to the intended recipient is carried out only if the intended recipient indicates that they wish to receive the gift.

3. A method according to claim 2 wherein the step of obtaining payment includes two stages:
A) obtaining payment authorization prior to notifying the intended recipient of the fact that a gift is intended for them; and
B) processing the payment only if the intended recipient indicates that they wish to receive the gift.

4. A method according to claim 2 further including the step of providing the intended recipient with information identifying the at least one physical item.

5. A method according to claim 2 further including the step of providing the intended recipient with information identifying the donor.

6. A system for gifting one or more physical items to a recipient including: preparation means for preparing gift information relating to a gift which a donor wishes to give to an intended recipient, the gift information including physical item information identifying at least one physical item, donor information identifying a donor, and recipient contact information enabling contact to be made with the intended recipient;
obtaining means for obtaining payment from the donor in relation to the gift and for obtaining delivery information derived from the intended recipient;
wherein the delivery information includes information identifying a delivery address or pick up location;
associating means for associating a donor transaction identifier with the gift information and for associating a recipient transaction identifier with the gift information;
wherein the donor transaction identifier is different to the recipient transaction identifier.

7. A software program including instructions which, when carried out by a processor, cause a computing system to operate a method according to claim 1.

8. A computer readable medium which is populated with a software program according to claim 7.

9. A software program including instructions which, when carried out by a processor, cause a computing system to embody a system according to claim 6.
